(19) United States
(12) Patent Application Publication
(10) Pub. No.: US 2022/0417283 A1
(43) Pub. Date: Dec. 29, 2022

(54) DETECTION METHOD OF SECURITY EQUIPMENT BASED ON ALG PROTOCOL TO REALIZE TCP STACK INFORMATION LEAK

(71) Applicant: WebRAY Tech (Beijing) Co.,Ltd., Beijing (CN)

(72) Inventors: Weidong HAN, Qingdao (CN); Xiaowen QUAN, Beijing (CN)

(21) Appl. No.: 17/257,029

(22) PCT Filed: Sep. 24, 2020
(86) PCT No.: PCT/CN2020/117342

§ 371 Date: Dec. 30, 2020

(30) Foreign Application Priority Data
Oct. 22, 2019 (CN) 201911005486.7

(51) Int. Cl. H04L 9/40

(52) U.S. Cl. CPC H04L 63/20; H04L 63/168; H04L 63/1416

(57) ABSTRACT

The present invention discloses a detection method of security equipment based on ALG protocol to realize TCP stack information leak, including: S1, a client sending a detection packet containing an ALG protocol stack to a server; S2, the server responding to the detection packet, wherein a response packet of the server in response to the detection packet includes basic information of a software to be detected and protocol stack information of the security equipment; S3, the client receiving the response packet. The detection method constructs a detection packet containing a protocol stack of a security equipment to enable the security equipment to return the corresponding protocol stack information, thereby recognizing the transparent deployed security equipment to achieve a genuine purpose of network equipment recognition.

### TECHNICAL FIELD

The present invention relates to the field of information technology and information security technology, in particular to a detection method of security equipment based on ALG protocol to realize TCP stack information leak.

### BACKGROUND

As a “fifth territory” after land, sea, air and sky, cyberspace has become a strategic focus of current competition among countries in the world. China has become an important country in the network world. Traditional production and life patterns are being changed by smart cities, digital China, Internet+, etc. Network security and informationization are important strategic issues related to national security, national development, and work and life of the people. The description and recognition of cyberspace equipments has become one of the basic conditions for managing cyberspace.

Network fingerprints are important recognition elements to describe the identities of cyberspace equipments, which play an important role in the recognition of cyberspace terminal equipments. The network fingerprints of the same type of the terminal equipments should have certain similarity, and the network fingerprints of different types of terminal equipments should have certain differences. The quality of the network fingerprints determines the final recognition effect. Therefore, the selection of the network fingerprints should be strict and standardized.

The network fingerprints comprise two levels: physical fingerprints (machines: comprising hardware, software, and service), and abstract fingerprints (humans: comprising usage and operation). Therefore, there are four types of objects that can be used as host network fingerprints: the hardware (clock, MAC address, hard disk serial number, etc.), the software (operation system type, browser type and version, etc.), the services (host name, port, system service, access control information, etc.) and usage (keystroke characteristics, traffic, and internet behavior habits). Network characteristics that can be used as the network fingerprints should have the following characteristics: uniqueness, stability, distinguishability, and measurability. The network fingerprints is applied to the cyberspace terminal equipments, which causes the following characteristics:

uniqueness: for an individual cyberspace terminal equipment, the result of the same detection being unique;

stability: for an individual cyberspace terminal equipment, the detection result being not related to the time, geographic location, IP address and network topology of the detection;

distinguishability: for different cyberspace terminal equipments, the detection result of the same detection being different; and

measurability: the network characteristic value of the cyberspace terminal equipment being capable of being measured according to a standard, and the network characteristic value being capable of being distinguished by a machine or a person.

For a terminal equipment, a detection request should be similar to a normal request, and it is not advisable to use a malformed request, to ensure that a detection process does not affect the stable operation of the terminal equipment. At the same time, a more comprehensive analysis of an obtained network fingerprint should be carried out because the requirements for the detection request are more stringent, and the content of a network communication traffic that can reflect the terminal equipment information should be fully explored, so as to obtain a better recognition effect under fewer detection requests.

Accurate recognition of the cyberspace equipments is a basic function of cyberspace governance. Currently, the main method for network fingerprint recognition is Banner recognition method, which is also known as a service annotation recognition method. Service sign (Banner) information recognition is a simple and effective recognition method, which can easily obtain the software type, and even accurate version information and operation system information, of a Web server of a detection target by Banner information. The server will respond to a request sent by a client, will feed back its own software name and version and other Banner basic information to the user in a response packet. When correspondingly connecting to a server running a network service, one can obtain Banner information returned by a remote host in default. But, the service recognition method based on Banner information has certain defects, such as:

1) Banner Tampering

Because the Banner information returned by a server can be artificially modified and disguised, the Banner recognition method cannot be 100% accurate. The usual practices can be divided into two types: one is to modify a source code or related binary files of the software in the server; and the other is to use a commercial software or server plug-ins to erase relevant Banner information, so as to achieve the purpose of being unable to recognize or error recognition.

2) A Packet that does not Respond to an Invalid Request for Banner Information

In a secure environment or a hardened environment, a server does not respond to a request from the client to the server. In this case, a Banner recognition method cannot be performed, and a target attribute cannot be determined, resulting in detection failure.

3) Erroneous Banner Information

As a network security equipment, such as a protective wall, an intrusion detection system, and a transparently deployed next-generation firewall, the returned Banner information is the equipment behind the security equipment. From the perspective of detection, the existence of the security system cannot be perceived. This detection method has big errors, and the detection of network security equipments cannot be accurately located.

### SUMMARY

An object of the present invention is to solve at least above problems, and to provide, at least, the advantages that will be described later.

An another object of the present invention is to provide a detection method of security equipment based on ALG protocol to realize TCP stack information leak, which constructs a detection packet containing a protocol stack of a security equipment to enable the security equipment to return the corresponding protocol stack information, thereby recognizing the transparent deployed security equipment to achieve a genuine purpose of network equipment recognition.

In view of the objects mentioned above and other advantages, the present invention provides a detection method of security equipment based on ALG protocol to realize TCP stack information leak, comprising the following steps of:

S1, a client sending a detection packet containing an ALG protocol stack to a server;

S2, the server responding to the detection packet, wherein a response packet of the server in response to the detection packet comprises basic information of a software to be detected and protocol stack information of security equipment; and

S3, the client receiving the response packet.

Preferably, in the detection method of security equipment based on ALG protocol to realize TCP stack information leak, the ALG protocol stack comprises one or more of FTP, H.323, SIP, SCCP, RTSP, PPTP, DNS, GRE, ORACLE SQL*Net, MS-RPC, Sun-RPC, TFTP and RSH.

Preferably, in the detection method of security equipment based on ALG protocol to realize TCP stack information leak, the basic information of the software to be detected comprises name, Web server software type, version information and operation system information.

Preferably, in the detection method of security equipment based on ALG protocol to realize TCP stack information leak, the security equipment comprises a protective wall, an intrusion detection system, and a transparently deployed firewall.

Preferably, in the detection method of security equipment based on ALG protocol to realize TCP stack information leak, the protocol stack information of the security equipment comprises a SYN packet and an ACK packet returned by the security equipment after receiving the ALG protocol stack.

Preferably, the detection method of security equipment based on ALG protocol to realize TCP stack information leak comprises the following steps of:

S1-1, a client sending a detection packet containing an ALG protocol stack to a server;

S1-2, the security equipment responding to the detection packet, and returning the SYN packet and the ACK packet to the client;

S1-3, the client sending the ACK packet again to the security equipment, and the security equipment sending the SYN packet to the server;

S1-4, the server returning an RST response packet to the security equipment;

S1-5, the security equipment returning a RST/FIN response packet containing the RST response packet to the client after receiving the RST response packet; and

S1-6, after receiving the RST/FIN response packet, the client recognizing the security equipment, and then analyzing the SYN packet and the ACK packet returned by the step S1-2 to obtain the type of the security equipment.

Preferably, in the detection method of security equipment based on ALG protocol to realize TCP stack information leak, in the step S1-6, the client recognizes the security equipment with different types by recognizing MSS and Windows information in the SYN packet and the ACK packet.

The present invention comprises at least the following substantial improvements and beneficial effects:

In the detection method of security equipment based on ALG protocol to realize TCP stack information leak of the present invention, the ALG protocol stack is added to the detection packet, so that the security equipment can respond to the ALG protocol stack in the detection packet during network equipment recognition. Therefore, the response packet returned to the client not only contains the basic information of the software to be detected, but also contains the protocol stack information of the security equipment, thereby realizing the detection of the security system in the network, avoiding false alarms, improving detection accuracy, and achieving the genuine purpose of network equipment recognition.

The recognition of network equipments is realized by constructing the detection packet containing the ALG protocol stack, which is simple and versatile. Therefore, the detection method is applicable to all equipments in the cyberspace, and is applicable to all industries related to equipment annotation and cyberspace equipment recognition.

Other advantages, objects, and features of the present invention will be showed in part through following description, and in part will be understood by those skilled in the art from study and practice of the present invention.

### BRIEF DESCRIPTION OF THE DRAWINGS

FIG. 1 shows a schematic diagram of the detection method of security equipment based on ALG protocol to realize TCP stack information leak according to the present invention.

### DETAILED DESCRIPTION

The present invention will now be described in further detail with reference to the accompanying drawings in order to enable person skilled in the art to practice with reference to the description.

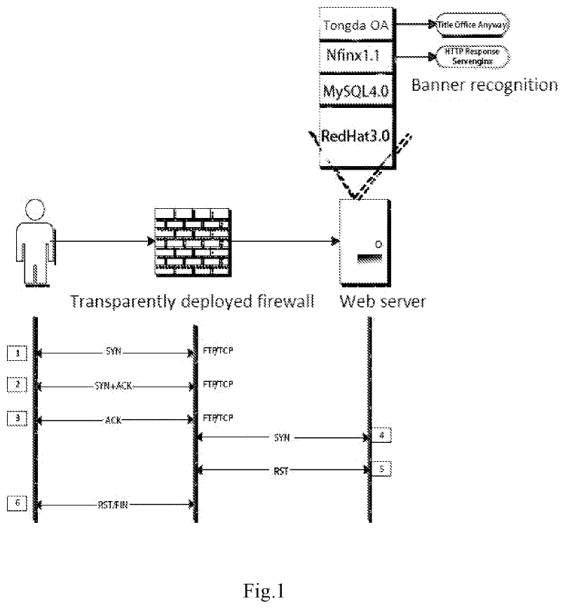

As shown in FIG. 1, a detection method of security equipment based on ALG protocol to realize TCP stack information leak comprises the following steps of:

S1, a client sending a detection packet containing an ALG protocol stack to a server;

S2, the server responding to the detection packet, wherein a response packet of the server in response to the detection packet comprises basic information of a software to be detected and protocol stack information of security equipment; and

S3, the client receiving the response packet.

In the above technical solution, the existence of the security equipment in the network can be obtained during detection by setting the ALG protocol stack in the detection packet, thereby realizing the detection of the security equipment.

The security equipment contains TCP/IP (a large collection of different communication protocols based on two original protocols of TCP and IP; wherein TCP stands for Transmission Control Protocol; IP stands for Internet Protocol). By default, FTP/PPTP (File Transfer Protocol/Point to Point Tunneling Protocol) is open, so it can be sent by the detection packet containing the ALG (Application Layer Gateway) protocol stack to the server, so that the security equipment realizes communication with the client by its own TCP/IP protocol stack when the security equipment encounters the ALG protocol stack, and then forwarding to the back-end server, thus avoiding the problem of the security equipment in the prior art directly forwarding the detection packet sent by the client to the back-end server without any data packet, thereby realizing the security equipment returning the corresponding protocol stack information to recognize the security equipment, that is, realizing the detection of a security system in the network, avoiding false alarms, improving detection accuracy, and achieving the genuine purpose of network equipment recognition.

In a preferred solution, the ALG protocol stack comprises one or more of FTP, H.323, SIP, SCCP, RTSP, PPTP, DNS, GRE, ORACLE SQL*Net, MS-RPC, Sun-RPC, TFTP and RSH.

In the above solution, FTP, H.323, SIP, SCCP, RTSP, PPTP, DNS, GRE, ORACLE SQL*Net, MS-RPC, Sun-RPC, TFTP and RSH are known as 13 Application Gateway Protocols in the prior art.

In a preferred solution, the basic information of the software to be detected comprises name, Web server software type, version information and operation system information.

In the above solution, the identity of the software to be detected can be accurately recognized by the above basic information.

In a preferred solution, the security equipment comprises a protective wall, an intrusion detection system, and a transparently deployed firewall.

In a preferred solution, the protocol stack information of the security equipment comprises a SYN packet and an ACK packet returned by the security equipment after receiving the ALG protocol stack.

In the above solution, the SYN packet refers to the Synchronize Sequence Numbers, and the SYN packet sets a sign to 1 for requesting a connection. The ACK packet refers to a request status or a response status, wherein 0 is request status, and 1 is response status.

As shown in FIG. 1, in a preferred solution, the detection method comprises the following steps of:

S1-1, a client sending a detection packet containing an ALG protocol stack to a server;

S1-2, the security equipment responding to the detection packet, and returning the SYN packet and the ACK packet to the client;

S1-3, the client sending the ACK packet again to the security equipment, and the security equipment sending the SYN packet to the server;

S1-4, the server returning an RST response packet to the security equipment;

S1-5, the security equipment returning a RST/FIN response packet containing the RST response packet to the client after receiving the RST response packet; and

S1-6, after receiving the RST/FIN response packet, the client recognizing the security equipment, and then analyzing the SYN packet and the ACK packet returned by the step S1-2 to obtain the type of the security equipment.

In the above solution, the existence of the security equipment in the network can be obtained during detection by setting the ALG protocol stack in the detection packet, thereby realizing the detection of the security equipment.

The security equipment contains TCP/IP (a large collection of different communication protocols based on two original protocols of TCP and IP; wherein TCP stands for Transmission Control Protocol; IP stands for Internet Protocol). By default, FTP/PPTP (File Transfer Protocol/Point to Point Tunneling Protocol) is open. Therefore, so it can be sent by the detection packet containing the ALG (Application Layer Gateway) protocol stack to the server, so that the security equipment realizes communication with the client by its own TCP/IP protocol stack when the security equipment encounters the ALG protocol stack, and then forwarding to the back-end server. That is, there are steps 3 and 6 as shown in FIG. 1, thus avoiding the problem of the security equipment in the prior art directly forwarding the detection packet sent by the client to the back-end server without any data packet. It realizes that the security equipment returns the corresponding protocol stack information, which not only realizes that the transparent security equipment can return the packet, but also realizes the purpose of specific security equipment recognition by the SYN packet and the ACK packet returned in the step 2 as shown in FIG. 1, thereby realizing the detection of a security system in the network, avoiding false alarms, improving detection accuracy, and achieving the genuine purpose of network equipment recognition.

In a preferred solution, in the step S1-6, the client recognizes the security equipment with different types by recognizing MSS and Windows information in the SYN packet and the ACK packet.

In the above solution, security equipments from different manufacturers have different MSS and Windows, so the client can recognize the manufacturer, model and other information of the specific security equipment in the network equipment by recognizing the MSS and Windows information in the SYN packet and the ACK packet.

Although the embodiments of the present invention have been disclosed above, they are not limited to the applications previously mentioned in the specification and embodiments, and can be applied in various fields suitable for the present invention. For ordinary skilled person in the field, other various changes may be easily achieved without creative work according to instruction of the present invention. Therefore, without departing the general concept defined by the claims and their equivalent, the present invention is not limited to particular details and illustrations shown and described herein.

What is claimed is:

1. A detection method of security equipment based on ALG protocol to realize TCP stack information leak, the detection method comprising the steps of:
S1, a client sending a detection packet containing an ALG protocol stack to a server;
S2, the server responding to the detection packet, wherein a response packet of the server in response to the detection packet comprises basic information of a software to be detected and protocol stack information of the security equipment; and
S3, the client receiving the response packet.

2. The detection method of security equipment based on ALG protocol to realize TCP stack information leak according to claim 1, wherein the ALG protocol stack comprises one or more of FTP, H.323, SIP, SCCP, RTSP, PPTP, DNS, GRE, ORACLE SQL*Net, MS-RPC, Sun-RPC, TFTP and RSH.

3. The detection method of security equipment based on ALG protocol to realize TCP stack information leak according to claim 1, wherein the basic information of the software to be detected comprises name, Web server software type, version information and operation system information.

4. The detection method of security equipment based on ALG protocol to realize TCP stack information leak according to claim 1, wherein the security equipment comprises a protective wall, an intrusion detection system, and a transparently deployed firewall.

5. The detection method of security equipment based on ALG protocol to realize TCP stack information leak according to claim 1, wherein the protocol stack information of the security equipment comprises a SYN packet and an ACK packet returned by the security equipment after receiving the ALG protocol stack.

6. The detection method of security equipment based on ALG protocol to realize TCP stack information leak according to claim 5, the detection method comprising the steps of:
S1-1, a client sending a detection packet containing an ALG protocol stack to a server;
S1-2, the security equipment responding to the detection packet, and returning the SYN packet and the ACK packet to the client;
S1-3, the client sending the ACK packet again to the security equipment, and the security equipment sending the SYN packet to the server;
S1-4, the server returning an RST response packet to the security equipment;
S1-5, the security equipment returning a RST/FIN response packet containing the RST response packet to the client after receiving the RST response packet; and
S1-6, after receiving the RST/FIN response packet, the client recognizing the security equipment, and then analyzing the SYN packet and the ACK packet returned by the step S1-2 to obtain the type of the security equipment.

7. The detection method of security equipment based on ALG protocol to realize TCP stack information leak according to claim 6, wherein in the step S1-6, the client recognizes the security equipment with different types by recognizing MSS and Windows information in the SYN packet and the ACK packet.
